(19) United States
(12) Patent Application Publication
(10) Pub. No.: US 2016/0180383 A1
(43) Pub. Date: Jun. 23, 2016

(54) AUTOMATIC CUSTOMER ATTRIBUTE SNAPSHOT FOR PREDICTIVE ANALYSIS

(71) Applicant: TERADATA US, INC., DAYTON, OH (US)

(72) Inventors: Muhammad Waqas Rajab, Raleigh, NC (US); Eric Navarro, Dayton, OH (US); Eleni Anna Rundle, Apex, NC (US); Paul Kristoff, Dayton, OH (US); Benjamin J. Ceranowski, Cary, NC (US); Gene Christopher Hovey, Raleigh, NC (US)

(73) Assignee: TERADATA US, INC., DAYTON, OH (US)

(21) Appl. No.: 14/581,177

(22) Filed: Dec. 23, 2014

(51) Int. Cl. G06Q 30/02

(52) U.S. Cl. CPC G06Q 30/0255

(57) ABSTRACT

Attributes, which are associated with successful customer results of a first marketing campaign, are archived and linked with that first marketing campaign. When an analyst wants to run a second campaign using the successful customer of the first campaign. The archived attributes are processed by a predictive analysis application to produce customer leads for the second campaign.

### BACKGROUND

Marketers often want to use the results of previous campaigns when building new campaigns. For example, a marketer can tabulate all the targets and responders from a campaign run last year. To run predictive analytics on this group, the marketer combines the attributes (for example gender, income, zip code, etc.) for the targets and responders and performs analytics like regression.

The problem with this approach is that the attributes used in the regression are the current values in the data repository. It is possible that some people (which were the subjects of a previous campaign and are being used for current predictive analysis for, perhaps, a new campaign) were married, divorced, retired between times they were initially marketed to and when a marketer is performing analysis for a new campaign that is using these prior campaign subjects as a model for the analysis.

Thus, the subjects' data associated with a previous campaign is potentially changing as time progresses. But, when a new campaign is run the attributes pulled (for the subjects being used as a model for predictive analysis of the new campaign) are attributes that are currently up-to-date in the data repository and the subjects' attributes have likely changed since the previous campaign was performed.

This situation taints any new predictive analysis that is performed by a marketer because the subjects are likely associated with changed attribute data from what was used for analysis of a prior campaign, which was processed in the past.

Therefore, there is a need to retain attribute data associated with subjects of a prior marketing analysis at the time of that analysis to ensure any subsequent analysis has the option to also be based off the retained attribute data.

### SUMMARY

In various embodiments, automated customer attribute snapshotting for predictive analysis is presented. According to an embodiment, a method for predictive analysis with customer attribute snapshotting is provided.

Specifically, a set of attributes associated with original customers that produced successful results for an original marketing campaign are archived. Subsequently, a request is received for a list of scored customer leads for a new marketing campaign based on the original customers. Finally, the archived set of attributes are passed to a predictive analysis application to generate the scored customer leads for the new marketing campaign.

### BRIEF DESCRIPTION OF THE DRAWINGS

FIG. 1 is diagram depicting components for predictive analysis with customer attribute snapshotting, according to an example embodiment.

FIG. 2 is a diagram of a method for predictive analysis with customer attribute snapshotting, according to an example embodiment.

FIG. 3 is a diagram of another method for predictive analysis with customer attribute snapshotting, according to an example embodiment.

FIG. 4 is a diagram of a predictive analysis customer attribute snapshotting system, according to an example embodiment.

### DETAILED DESCRIPTION

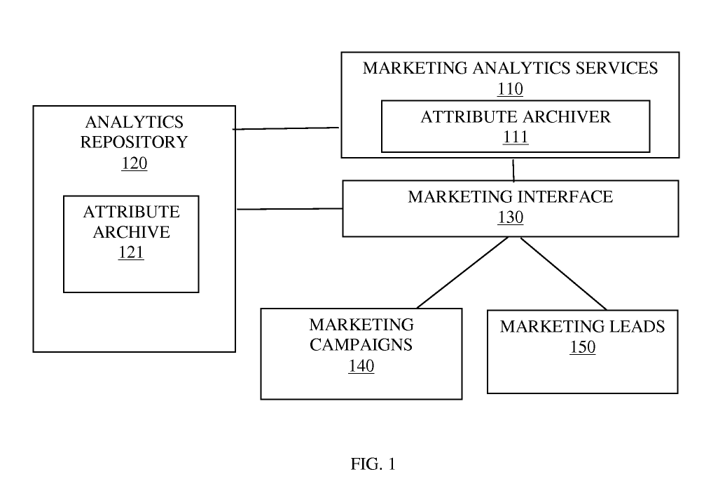

FIG. 1 is diagram depicting components for predictive analysis with customer attribute snapshotting, according to an example embodiment. The diagram depicts a variety of components, some of which are executable instructions implemented as one or more software modules, which are programmed within memory and/or non-transitory computer-readable storage media and executed on one or more processing devices (having memory, storage, network connections, one or more processors, etc.).

The diagram is depicted in greatly simplified form with only those components necessary for understanding embodiments of the invention depicted. It is to be understood that other components may be present without departing from the teachings provided herein.

The diagram includes a marketing analytics services server or servers (marketing analytics services 110), an analytics repository 120 (data warehouse), a marketing interface 130, a variety of instances of marketing campaigns 140, and a variety of instances marketing leads 150.

The marketing analytics services 110 includes an attribute archiver 111. The analytics repository 120 includes an attribute archive 121.

As used herein, the terms and morphological roots associated with the terms “archive” and “snapshot” may be used interchangeably and synonymously.

The marketing services 110 include a variety of applications that interacts with the marketing interface 130 (operated by a marketer (analyst)) and that use data defined in the analytics repository 120 to provide marketing applications to the analyst.

The marketing services 110 can include a variety of applications, one of which is a predictive analysis application (analytics engine). The predictive analysis application uses instances of predictive modules generated by data gathered and clipped by an analyst during a communication with a customer, perhaps during a particular marketing campaign 140. Interactions with customers and data gathered and clipped are provide through the marketing interface 130 and housed in the analytics repository (data warehouse).

The predictive analysis application can apply the predictive modules against communications or customer segments to generate a scoring (sometimes referred to a as a training). The result of submitting the training to the predictive analysis application against a communication or a segment (of desired customers) is an analytic schema for selection and clipping, each marketing lead 150 is then clipped or selected based on the score provided.

After an analyst trains a predictive module to create a training, the analyst can use the training to score a segment having potential customer (marketing leads) for a desired marketing campaign 140. The segment that the analyst scores is referred to as a scoring segment. When the analyst scores a scoring segment, each customer in the scoring segment indicates how likely the customer will respond to a communication. The scores may also be used by the analyst using the marketing interface 130 to build a new segment with the potential best customers (marketing leads 150), or clip an existing segment for a communication.

The predictive analysis, based on predictive modules, uses a variety of data from the analytics repository 120 (data warehouse) to perform statistical regression and predict how customers are going to respond to given proposed communication or marketing campaign 140 that an analyst wants to do by identifying leads 150 or customer segments for the analyst to pursue.

Sometimes, an analyst wants to process predictive analysis on customers that responded favorably to the analyst during previous campaigns 140 (successful results with particular customers during those previous campaigns 140). Currently, in the industry, this is problematic for the reasons discussed above (attributes of customers change over time, such that if customers had one set of attributes during a previous campaign 140 those same set of attributes are likely different when the analyst wants to run the predictive analysis (predictive analysis application)).

These issues are solved herein. For example, when a campaign 140 or a communication (data captured by the analyst for the communication) during the campaign 140 is processed against an identified set of customers (using the predictive analysis application of the marketing services 110 through the marketing interface 120), the attribute archiver 111 can capture a list of defined attributes, which are associated with the customers (which produced successful results for the campaign 140) or the segment, in the attribute archive 121 and link that set of attributes to the campaign 140.

In an embodiment, the list of predefined attributes archived for campaign 140 or communications during the course of executing the campaign 140 are only attributes at the contact level and higher. So, if a customer is being contacted, attributes at the household and customer levels are archived (e.g., household income, household members, home owner, zip code of residence, customer income, customer gender, customer age, etc.); however, attributes at lower levels need not be archived, such as account number, etc.

The attribute archiver 111 also provides the ability for an analyst through the marketing interface 130 to run a subsequent campaign 140 (at a further date in time from when an original campaign 140 was run) through the predictive analysis application using the set of attributes archived attributes associated with successful customer results from the original campaign 140). The archived attributes (which were gathered for the original campaign 140) are processed by the predictive analysis application to identify scored leads 150 (based on those previous archive set of attributes and not based on specific customers of the previous campaign 140, which may have changed attributes for the new campaign 140).

So, when an analyst desires to run a new campaign 140 but wants to run predictive analysis to score leads 150 for that campaign 140 and wants to base it off the customer segments or customers that were successful in a previous campaign 140, the analyst can instead use the attributes of those previous successful customers or previous successful customer segments from the previous campaign 140 to run the predictive analysis against the new campaign 140 to score leads 150 for the new campaign 140. This may or may not actually include customers from the original campaign 140 as part of the leads 150 produced by the predictive analysis application for the new campaign 140.

In this way, any customer associated with a previous campaign 140 having changed attributes at the time of the new campaign 140 will not pollute the predictive analysis for the new campaign 140 with those changed attributes because the leads 150 or customer segments are scored not based on the changed attributes of a customer of a previous campaign 140, but based on a set of the archived attributes in the attribute archive 121 that were successful in the previous campaign 140. Therefore, the produced scoring for the leads 150 in the new campaign 140 are more accurate and more likely to produce successful results for the marketer/analyst.

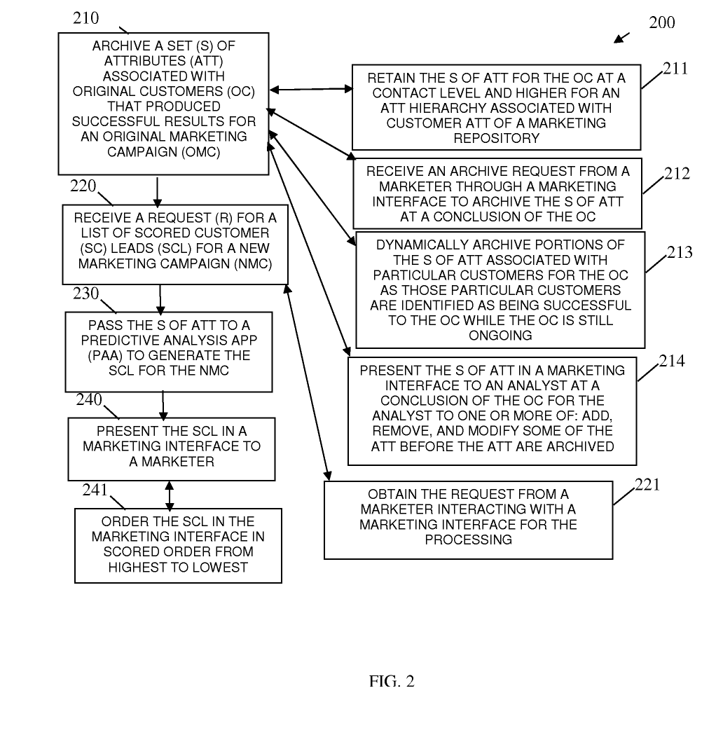

The above-discussed embodiments and other embodiments are now discussed with reference to the FIGS. 2-4.

FIG. 2 is a diagram of a method 200 for predictive analysis with customer attribute snapshotting, according to an example embodiment. The method 200 (hereinafter “attribute snapshot manager”) is implemented as executable instructions (as one or more software modules) within memory and/or non-transitory computer-readable storage medium that execute on one or more processors, the processors specifically configured to execute the attribute snapshot manager. Moreover, the attribute snapshot manager is programmed within memory and/or a non-transitory computer-readable storage medium. The attribute snapshot manager may have access to one or more networks, which can be wired, wireless, or a combination of wired and wireless.

In an embodiment, the attribute snapshot manager implements, inter alia, the techniques discussed above with reference to the FIG. 1.

At 210, the attribute snapshot manager archives a set of attributes associated with original customers that produced successful results for an original marketing campaign.

In an embodiment, at 211, the attribute snapshot manager retains the set of attributes at a contact level and higher for an attribute hierarchy associated with customer attributes of a marketing repository (data warehouse).

In an embodiment, the types of attributes archived and the level within the attribute hierarch for those types of attributes are predefined, such that attribute snapshot manager can obtain the set of attributes for archival.

According to an embodiment, at 212, the attribute snapshot manager receives an archive request from a marketer through a marketing interface to archive the set of attributes at a conclusion of the original campaign. Here, the marketer (operating the marketing interface) determines when the set of attributes are to be archived.

In an embodiment, at 213, the attribute snapshot manager dynamically archives portions of the set of attributes associated with particular customers for the original campaign as those particular customers are identified as being successful to the original campaign while the original campaign is ongoing. That is, the original campaign may be an ongoing or continuous campaign or one associated with an extended length of time, such that as particular customers are identified during the extended campaign, the attributes associated with those particular customers are dynamically archived.

In an embodiment, at 214, the attribute snapshot manager presents the set of attributes in a marketing interface to an analyst at a conclusion of the original campaign for the analyst to decide one or more of: adding different attributes, removing attributes, and modifying some of the attributes before the attributes are archived. This gives the analyst control over the archived attributes, if such control is desired by a marketing enterprise.

At 220, the attribute snapshot manager receives a request for a list of scored leads customer leads for a new marketing campaign that a marketer desires to perform a variety of communications associated with.

According to an embodiment, at 221, the attribute snapshot manager obtains the request from the marketer that is interacting with or operating a marketing interface for the attribute snapshot manager.

In an embodiment, the marketing interface is the marketing interface 130 of the FIG. 1.

At 230, the attribute snapshot manager passes the set of attributes to a predictive analysis application to generate the scored customer leads for the new marketing campaign. That is, the predictive analysis application uses attributes associated with customers that produced successful results for the original marketing campaign where those attributes had been snapshotted or archived at the time the customers were associated with successful results for the original marketing campaign. So, if any attributes associated with those customers that produced successful results change between the time those customers were identified with the successful results and the time the predictive analysis application processes the attributes, the predictive analysis application uses the snapshotted attributes and results for producing leads are more likely to be more accurate.

In an embodiment, the predictive analysis application is part of the marketing services of the FIG. 1.

According to an embodiment, at 240, the attribute snapshot manager presents the scored customer leads in a marketing interface to a marketer.

In an embodiment of 240 and at 241, the attribute snapshot manager orders the scored customer leads in scored order from highest score to lowest score within the marketing interface.

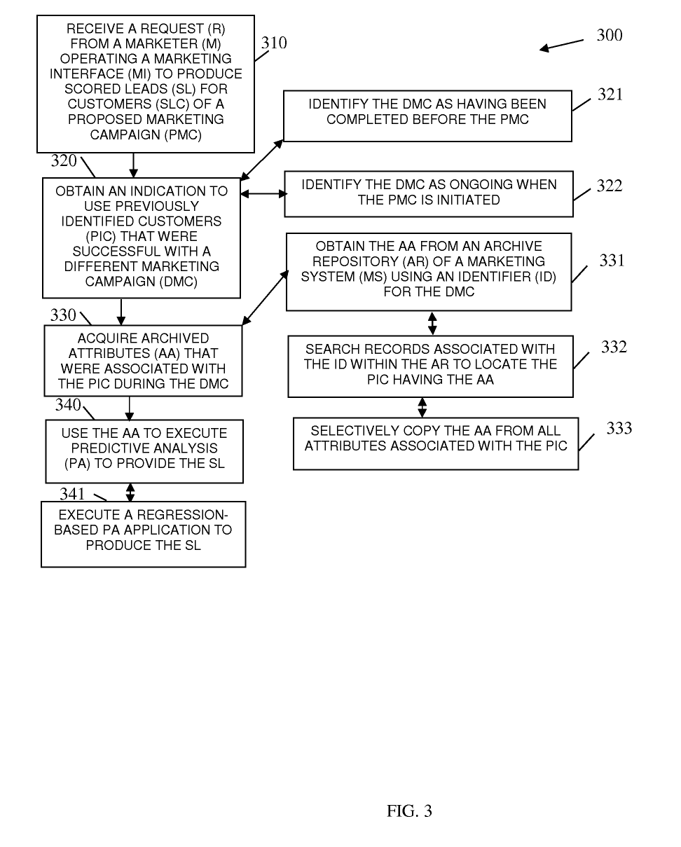

FIG. 3 is a diagram of another method 300 for predictive analysis with customer attribute snapshotting, according to an example embodiment. The method 300 (hereinafter “attribute manager”) is implemented as executable instructions as one or more software modules within memory and/or a non-transitory computer-readable storage medium that execute on one or more processors, the processors specifically configured to execute the attribute manager. Moreover, the attribute manager is programmed within memory and/or a non-transitory computer-readable storage medium. The attribute manager has access to one or more network, which can be wired, wireless, or a combination of wired and wireless.

The attribute manager represents another processing perspective and, perhaps, an enhanced processing perspective to that which was shown above with the discussion of the attribute snapshot manager of the FIG. 1.

In an embodiment, the attribute manager implements, inter alia, the techniques discussed above with reference to the FIG. 1.

In an embodiment, the attribute manager implements, inter alia, the techniques discussed above with reference to the FIG. 2.

At 310, the attribute manager receives a request from a marketer operating a marketing interface to produce scored leads for customers of a proposed marketing campaign.

At 320, the attribute manager obtains an indication to use previously identified customers that were successful with a different marketing campaign.

In an embodiment, at 321, the attribute manager identifies the different marketing campaign as having been completed at some point in time before the proposed marketing campaign is initiated.

In an embodiment, at 322, the attribute manager identifies the different marketing campaign as ongoing when the proposed marketing campaign is initiated. This situation was discussed above with reference to the FIG. 2.

At 330, the attribute manager acquires archived or snapshotted attributes that were associated with the previously identified customers that were a success with the different marketing campaign.

In an embodiment, at 331, the attribute manager obtains the archived or snapshotted attributes from an archive or snapshot repository of a marketing system using an identifier for the different marketing campaign.

In an embodiment of 331 and at 332, the attribute manager searches records associated with the identifier within the archive or snapshotted repository to locate the previous customers that were successful in the different campaign and these customers have the archived or snapshotted attributes.

In an embodiment of 332 and at 333, the attribute manager selectively copies the archived or snapshotted attributes from all attributes associated with the previously identified customers that were successful in the different campaign. That is, only attributes at a contact level and higher of a customer attribute hierarchy in a marketing system are used from all of the available attributes as the archived or snapshotted attributes.

At 340, the attribute manager uses the archived or snapshotted attributes to execute predictive analysis to produce and provide the scored customer leads from a marketing repository of all available customers. These leads are provided to the marketer in the marketing interface.

In an embodiment of 340 and at 341, the attribute manager executes a regression-based predictive analysis application to produce the scored customer leads for the proposed marketing campaign.

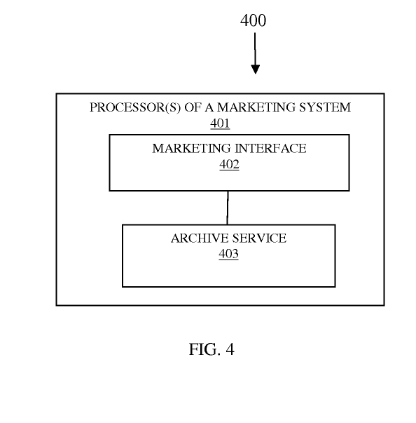

FIG. 4 is a diagram of a predictive analysis customer attribute snapshotting system 400, according to an example embodiment. The predictive analysis customer attribute snapshotting system 400 includes hardware components, such as memory and one or more processors. Moreover, the predictive analysis customer attribute snapshotting system 400 includes software resources, which are implemented, reside, and are programmed within memory and/or a non-transitory computer-readable storage medium and execute on the one or more processors, specifically configured to execute the software resources. Moreover, the predictive analysis customer attribute snapshotting system 400 has access to one or more networks, which are wired, wireless, or a combination of wired and wireless.

In an embodiment, the predictive analysis customer attribute snapshotting system 400 implements, inter alia, the techniques of the FIG. 1

In an embodiment, the predictive analysis customer attribute snapshotting system 400 implements, inter alia, the techniques of the FIG. 2.

In an embodiment, the predictive analysis customer attribute snapshotting system 400 implements, inter alia, the techniques of the FIG. 3

In an embodiment, the predictive analysis customer attribute snapshotting system 400 implements, inter alia, the techniques of the FIG. 1 and the FIG. 2.

The predictive analysis customer attribute snapshotting system 400 includes processor(s) 401 of a marketing system, a marketing interface 402, and an archive/snapshot service 403.

The archive/snapshot service 403 is configured to: execute on the processor(s) 401 and present options to a marketer to select customers identified as successful to a first campaign to use as seeds to identify leads of a second campaign.

The archive/snapshot service 403 is configured to: execute on the processor(s) 401, snapshot attributes for all customers identified as successful to the first marketing campaign as each of the customers are identified as being successful to the first marketing campaign, call a predictive analysis application with the snapshotted attributes for the marketer selected customers, and pass scored leads of customers mined from a marketing repository by the predictive analysis application to the marketing interface for use by the marketer in the second marketing campaign.

According to an embodiment, at least some of the marker selected customers have different attributes from their corresponding snapshotted attributes within the marketing repository at a time that the predictive analysis application is executed.

In an embodiment, the set of scored leads for customers of the second marketing campaign is different from the marketer selected customers.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
archiving, by a processor, a set of attributes associated with original customers that produced successful results for an original marketing campaign;
receiving, by the processor, a request for a list of scored customer leads for a new marketing campaign using the original customers; and
passing, by the processor, the archived set of attributes to a predictive analysis application to generate the scored customer leads for the new marketing campaign.

2. The method of claim 1 further comprising, by the processor, presenting the scored customer leads in a marketing interface to a marketer.

3. The method of claim 2, wherein presenting further includes ordering the scored customer leads in the marketing interface in scored order from highest to lowest.

4. The method of claim 1, wherein archiving further includes retaining the set of attributes for the original customers at a contact level and higher for an attribute hierarchy associated customer attributes of a marketing repository.

5. The method of claim 1, wherein archiving further includes receiving an archive request from a marketer through a marketing interface to archive the set of attributes at a conclusion of the original campaign.

6. The method of claim 1, wherein archiving further includes dynamically archiving portions of the set of attributes associated with particular customers for the original campaign as those particular customers are identified as being successful to the original campaign while the original campaign is still occurring.

7. The method of claim 1, wherein archiving further includes presenting the set of attributes in a marketing interface to an analyst at a conclusion of the original campaign for the analyst to one of more of: add, remove, and modify some of the attributes before the set of attributes are archived.

8. The method of claim 1, wherein receiving further includes obtaining the request from a marketer interacting with a marketing interface for the method .

9. A method, comprising:
receiving, by a processor, a request from a marketer operating a marketing interface to produced scored leads for customers of a proposed marketing campaign;
obtaining, by the processor, an indication to use previously identified customers that were successful with a different marketing campaign;
acquiring, by the processor, archived attributes that were associated with the previously identified customers during the different marketing campaign; and
using, by the processing, the archived attributes to execute predictive analysis to provide the scored leads.

10. The method of claim 9 further comprising, presenting the scored leads to the marketer in the marketing interface.

11. The method of claim 9 further comprising, recognizing that the scored leads produces a different set of customers than that which is associated with the previously identified customers.

12. The method of claim 9, wherein obtaining further includes identifying the different marketing campaign as having been completed before the proposed marketing campaign is initiated.

13. The method of claim 9, wherein obtaining further includes identifying the different marketing campaign as ongoing when the proposed marketing campaign is initiated.

14. The method of claim 9, wherein acquiring further includes obtaining the archived attributes from an archive repository of a marketing system using an identifier for the different marketing campaign.

15. The method of claim 14, wherein obtaining further includes searching records associated with the identifier within the archive repository to locate the previously identified customers having the archived attributes.

16. The method of claim 15, wherein searching further includes selectively copying the archived attributes from all attributes associated with the previously identified customers.

17. The method of claim 9, wherein using further includes executing a regression-based predictive analysis application to produce the scored leads.

18. A system, comprising:
a processor of a marketing system;
a marketing interface configured to: i) execute on the processor and ii) present options to a marketer to select customers identified as successful to a first campaign to use as seeds to identify leads of a second marketing campaign; and
an archive service configured to: i) execute on the processor, ii) snapshot attributes for all customers identified as successful to the first marketing campaign as each of the customers are identified as being successful to the first marketing campaign, iii) call a predictive analysis application with the snapshotted attributes for the marketer selected customers, and iv) pass scored leads of customers mined from a marketing repository by the predictive analysis application to the marketing interface for use by the marketer in the second marketing campaign.

19. The system of claim 18, wherein at least some of the marketer selected customers have different attributes from their corresponding snapshotted attributes within the marketing repository at a time that the predictive analysis application is executed.

20. The system of claim 18, wherein the set of scored leads is different from the marketer selected customers.
